(19) United States
(12) Patent Application Publication
(10) Pub. No.: US 2003/0056630 A1
(43) Pub. Date: Mar. 27, 2003

(54) Miter guide

(76) Inventor: Euther Phillips, Mineral Wells, TX (US)

Correspondence Address: HENDERSON & STURM LLP, 1213 MIDLAND BUILDING, 206 SIXTH AVENUE, DES MOINES, IA, 50309-4076, US

(21) Appl. No.: 09/957,793

(22) Filed: Sep. 21, 2001

(51) Int. Cl. B27B 27/08; B26D 7/06; B27B 27/10

(52) U.S. Cl. 83/441; 83/468.3; 83/468; 83/468.4; 83/468.5; 83/468.7

(57) ABSTRACT

The present invention provides a miter guide for a table saw that allows the operator to make a miter cut with a slope in a single pass of the workpiece past the cutting blade. The miter guide includes a base within a pivotally attached guide bar that slidably engages the alignment groove in the work table of a table saw. The base is thus pivotably about a vertical axis to one of a selected number of angular orientations with respect to the cutting blade to provide the miter cut desired. A work platform that receives the workpiece to be cut is pivotally attached to the base about a horizontal axis and is thereby adjustable to a number of angular orientations with respect to the base to provide the desired slope to the miter cut.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the field of woodworking accessories, and more particularly to an adjustable miter guide.

2. Description of Related Art

As can be seen by reference to the following U.S. Pat. Nos. 4,165,668; 4,693,156; 4,989,485 and 5,979,283, the prior art is replete with myriad and diverse miter guides.

While all of the aforementioned prior art constructions are more than adequate for the basic purpose and function for which they have been specifically designed, they are uniformly deficient with respect to their failure to provide a simple, efficient, and practical miter guide that allows a miter cut with a slope to the miter.

As a consequence of the foregoing situation, there has existed a longstanding need for a new and improved miter guide and the provision of such a construction is a stated objective of the present invention.

### BRIEF SUMMARY OF THE INVENTION

Briefly stated, the present invention provides a miter guide for a table saw that allows the operator to make a miter cut with a slope in a single pass of the workpiece past the cutting blade. The miter guide includes a base with a pivotally attached guide bar that slidably engages the alignment groove in the work table of a table saw. The base is thus pivotable about a vertical axis to one of a selected number of angular orientations with respect to the cutting blade to provide the miter cut desired. A work platform that receives the workpiece to be cut is pivotally attached to the base about a horizontal axis and is thereby adjustable to a number of angular orientations with respect to the base to provide the desired slope to the miter cut.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view showing the miter guide of the present invention on a table saw;

FIG. 2 is an enlarged perspective view of the miter guide;

FIG. 3 is an exploded perspective view of the miter guide showing the components;

FIG. 4 is a side elevational view illustrating the angular adjustment of the work platform with respect to the base;

FIG. 5 is an enlarged sectional view taken along line 5-5 of FIG. 4 and illustrating the operation of the miter adjustment lever; and

FIG. 6 is a top plan view with a portion cut away to show the base, and illustrate the angular adjustment of the base with respect to the guide bar and thus the cutting blade of the table saw.

### DETAILED DESCRIPTION OF THE INVENTION

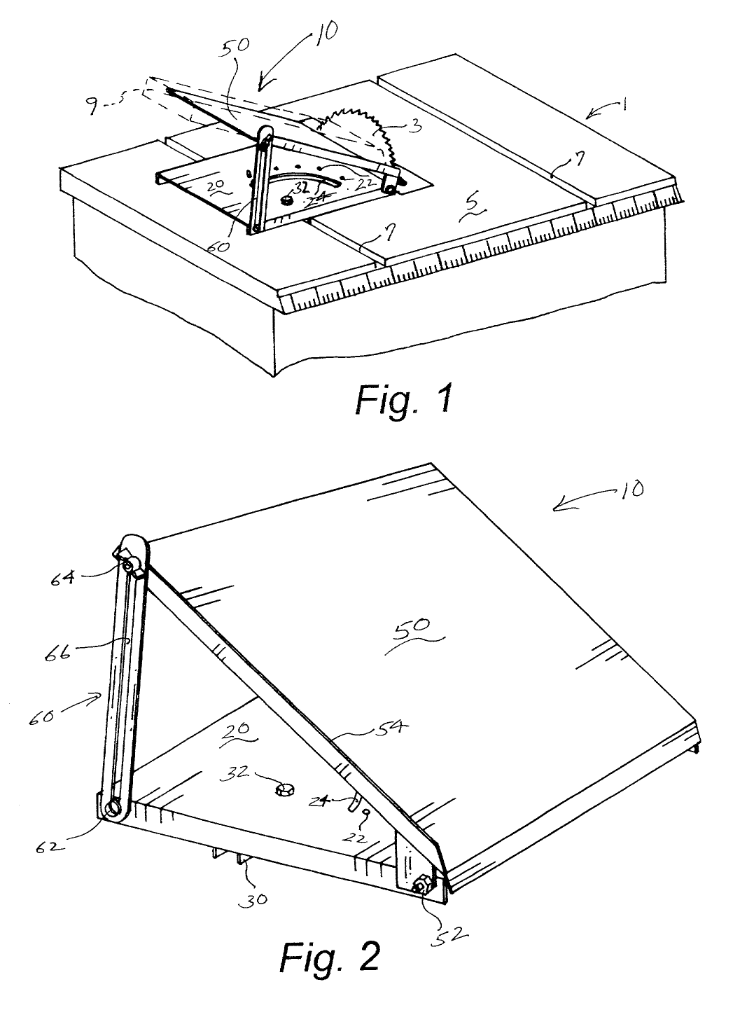

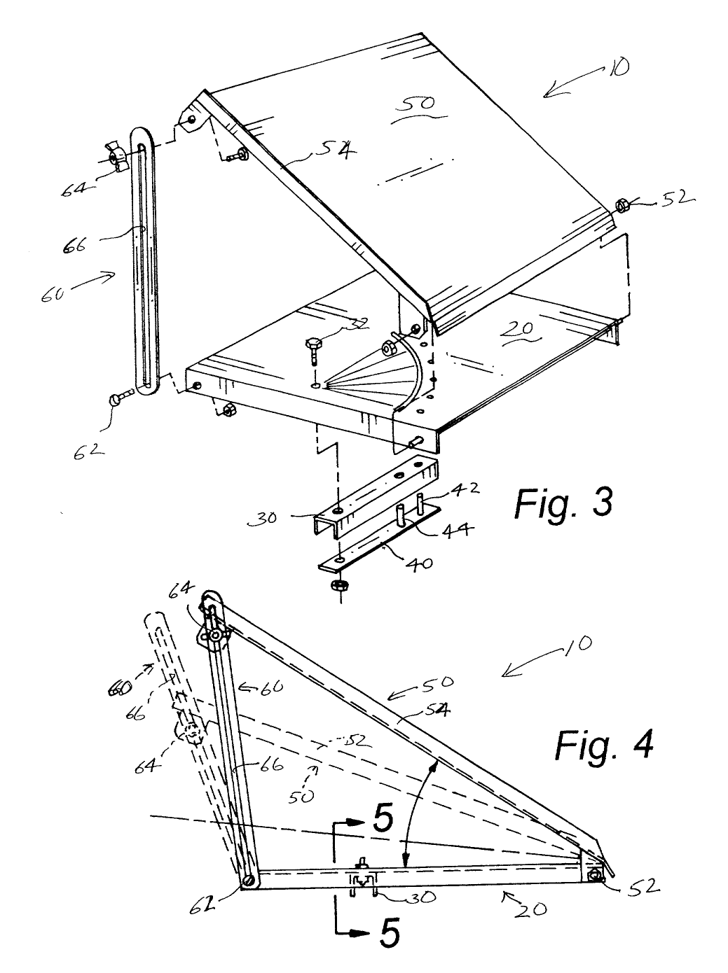

As can be seen by reference to the drawings, and in particularly to FIG. 1, the miter guide that forms the basis of the present invention is designated generally by the reference number 10. The miter guide 10 is used with a table saw 1 that has a cutting blade 3 and a work table 5 with alignment grooves 7 that extend parallel to the cutting blade 3. As best shown in FIGS. 2 and 3, the miter guide 10 includes a base 20 with a pivotally attached guide bar 30 that is slidably received in one of the alignment grooves 7. The guide bar 30 is attached to the base 20 by a fastener 32 which provides a vertical axis for pivotal movement.

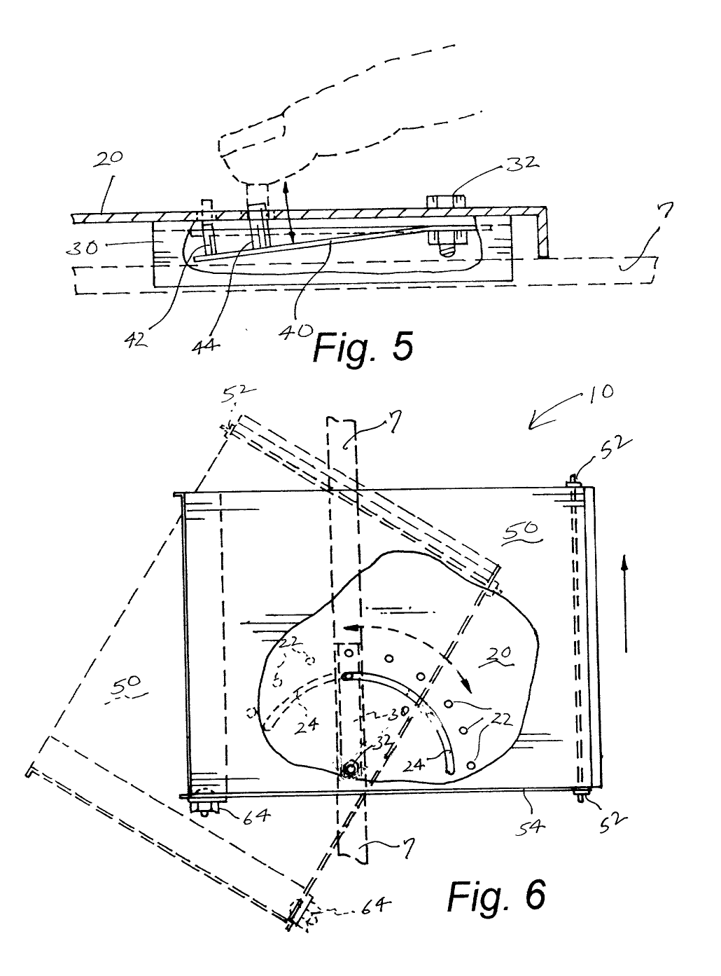

The base 20 has a series of spaced openings 22 arranged in an arcuate path and an arcuate slot 24 that is disposed concentric to the arcuate path. A resilient miter adjustment lever 40 is attached below the guide bar 30 by the fastener 32. The lever 40 has an upwardly extending pin 42 that is disposed to selectively engage a selected one of the openings 22, and an upwardly extending actuator button 44 that slidably engages the arcuate slot 24. As shown in FIG. 5, the pin 42 and the button 44 are movable downwardly and are upwardly biased since the resilient lever 40 is attached only at one end by the fastener 32.

A work platform 50 is pivotally attached to the base 20 by fasteners 52 which provides a horizontal axis for pivotal movement. The leading edge of the platform 50 has an upwardly extending guide edge 54 that engages an edge of the workpiece 9. A slope adjustment arm 60 is attached to the base 20 and the platform 50 by fasteners 62 and 64. Fastener 64 slidably engages slot 66 and locks the platform 50 in the desired angular orientation with respect to the base 20 as illustrated in FIG. 4.

In operation, the miter guide 10 is placed on the table saw 1 with the guide bar 30 slidably engaging the alignment slot 7. The actuator button 44 of the miter adjustment lever 40 is depressed as shown in FIG. 5 and the base 20 is pivoted to the selected angular orientation with respect to the cutting blade 3 as illustrated in FIG. 6. The button 44 is then released which allows the pin 42 to move up to engage the selected opening 22 to lock the base 20 at the desired angle for the miter cut. The fastener 64 is then loosened and the work platform 50 is moved to the desired angular orientation with respect to the base 20 for the desired slope cut as illustrated in FIG. 4. The workpiece 9 is then placed on the work platform 50 so that it engages the guide edge 54 and the miter guide 10 is advanced forwardly along the alignment slot 7 so that a miter cut with a slope is cut by the cutting blade 3 in a single pass.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. A miter guide for a table saw having a cutting blade and a work table with at least one alignment groove extending substantially parallel to the cutting blade, the miter guide comprising:
a base including a pivotally attached guide bar extending down from the base and being slidable received in the alignment groove, the base being pivotally adjustable about a vertical axis and being lockable in one of a selected number of angular orientations with respect to the cutting blade; and
a work platform pivotally attached about a horizontal axis to the base, the work platform being disposed to receive a workpiece and being adjustable and lockable in one of a selected number of angular orientations with respect to the base.

2. The miter guide of claim 1 further including a guide edge extending up from an edge of the work platform and being disposed to engage an edge of the workpiece.

3. The miter guide of claim 1 further including a slope adjustment arm adjustably attached to and interconnecting the base and the work platform at a point remote from the horizontal axis.

4. The miter guide of claim 2 further including a slope adjustment arm adjustably attached to and interconnecting the base and the work platform at a point remote from the horizontal axis.

5. The miter guide of claim 3 wherein the slope adjustment arm is slidably adjustably attached to the work platform.

6. The miter guide of claim 4 wherein the slope adjustment arm is slidably adjustably attached to the work platform.

7. The miter guide of claim 1 further including a miter adjustment lever attached to and interconnecting the guide bar and the base at a point remote from the vertical axis.

8. The miter guide of claim 2 further including a miter adjustment lever attached to and interconnecting the guide bar and the base at a point remote from the vertical axis.

9. The miter guide of claim 3 further including a miter adjustment lever attached to and interconnecting the guide bar and the base at a point remote from the vertical axis.

10. The miter guide of claim 4 further including a miter adjustment lever attached to and interconnecting the guide bar and the base at a point remote from the vertical axis.

11. The miter guide of claim 5 further including a miter adjustment lever attached to and interconnecting the guide bar and the base at a point remote from the vertical axis.

12. The miter guide of claim 6 further including a miter adjustment lever attached to and interconnecting the guide bar and the base at a point remote from the vertical axis.

13. The miter guide of claim 7 wherein:
the base includes a series of openings arranged in an arcuate path, and an arcuate slot disposed concentric to the arcuate path; and
wherein the miter adjustment lever includes a pin disposed to selectively engage one of the series of openings and being biased toward the base, and an actuator button disposed to slidably engage the arcuate slot and being selectively moveable to temporarily move the pin out of engagement with one of the series of openings, whereby the base may be pivoted with respect to the guide bar and the cutting blade.

14. The miter guide of claim 8 wherein:
the base includes a series of openings arranged in an arcuate path, and an arcuate slot disposed concentric to the arcuate path; and
wherein the miter adjustment lever includes a pin disposed to selectively engage one of the series of openings and being biased toward the base, and an actuator button disposed to slidably engage the arcuate slot and being selectively moveable to temporarily move the pin out of engagement with one of the series of openings, whereby the base may be pivoted with respect to the guide bar and the cutting blade.

15. The miter guide of claim 9 wherein:
the base includes a series of openings arranged in an arcuate path, and an arcuate slot disposed concentric to the arcuate path; and
wherein the miter adjustment lever includes a pin disposed to selectively engage one of the series of openings and being biased toward the base, and an actuator button disposed to slidably engage the arcuate slot and being selectively moveable to temporarily move the pin out of engagement with one of the series of openings, whereby the base may be pivoted with respect to the guide bar and the cutting blade.

16. The miter guide of claim 10 wherein:
the base includes a series of openings arranged in an arcuate path, and an arcuate slot disposed concentric to the arcuate path; and
wherein the miter adjustment lever includes a pin disposed to selectively engage one of the series of openings and being biased toward the base, and an actuator button disposed to slidably engage the arcuate slot and being selectively moveable to temporarily move the pin out of engagement with one of the series of openings, whereby the base may be pivoted with respect to the guide bar and the cutting blade.

17. The miter guide of claim 11 wherein:
the base includes a series of openings arranged in an arcuate path, and an arcuate slot disposed concentric to the arcuate path; and
wherein the miter adjustment lever includes a pin disposed to selectively engage one of the series of openings and being biased toward the base, and an actuator button disposed to slidably engage the arcuate slot and being selectively moveable to temporarily move the pin out of engagement with one of the series of openings, whereby the base may be pivoted with respect to the guide bar and the cutting blade.

18. The miter guide of claim 12 wherein:
the base includes a series of openings arranged in an arcuate path, and an arcuate slot disposed concentric to the arcuate path; and
wherein the miter adjustment lever includes a pin disposed to selectively engage one of the series of openings and being biased toward the base, and an actuator button disposed to slidably engage the arcuate slot and being selectively moveable to temporarily move the pin out of engagement with one of the series of openings, whereby the base may be pivoted with respect to the guide bar and the cutting blade.
